(19) United States
(12) Patent Application Publication
(10) Pub. No.: US 2022/0083159 A1
(43) Pub. Date: Mar. 17, 2022

(54) EQUIPMENT FOR A COMPUTER PERIPHERAL

(71) Applicant: LEXIP, La Ravoire (FR)

(72) Inventors: Lionel Chataignier, La Ravoire (FR); Geoffrey Chataignier, La Ravoire (FR); Léo Giorgis, La Ravoire (FR); Hugo Loi, La Ravoire (FR)

(73) Assignee: LEXIP, La Ravoire (FR)

(21) Appl. No.: 17/419,925

(22) PCT Filed: Dec. 27, 2019
(86) PCT No.: PCT/EP2019/087077

§ 371 Date: Jun. 30, 2021

(30) Foreign Application Priority Data
Jan. 4, 2019 (FR) 1900084

(51) Int. Cl. G06F 3/0354; G06F 3/039

(52) U.S. Cl. CPC G06F 3/03543; G06F 3/039

(57) ABSTRACT

Equipment item (43) for a computer (1) peripheral (5), characterized in that it comprises a set of at least four runners (21, 22, 23, 24) intended to be fastened below a base (10) of a peripheral (5), the peripheral (5) being intended to slide on a support (6), the base (10) being intended to face the support (6), in particular the peripheral (5) being a computer mouse, each runner (21, 22, 23, 24) of the equipment item (5) comprising a first ceramic surface (33) in the form of a portion of a sphere (31) and a fastening means (38) for fastening the runner (21, 22, 23, 24) below a base (10) of a peripheral (5).

The invention relates to an equipment item for a computer peripheral, in particular fora computer mouse. The invention also concerns a method for mounting such an equipment item. The invention additionally concerns a computer peripheral provided with such an equipment item. The invention further concerns a computer comprising such a peripheral.

Computers are tools used daily by numerous people for work or for leisure. Computers generally comprise a screen able to display a pointer, and a peripheral provided with a sliding surface, in particular a computer mouse. The sliding surface is arranged on at least one part of a base of the mouse and is intended to come into contact with a flat support. The movement of this peripheral on a flat surface makes it possible to move the pointer displayed on the screen and thus execute various commands. For this purpose, a sensor, for example an optical sensor, is generally provided below the base of the peripheral in such a way as to detect the translational movement of the peripheral with respect to a support.

For effective use of a computer, the position of the pointer must be able to be precisely controlled without effort. To achieve this aim, manufacturers of peripherals, and in particular of computer mice, generally provide sliding runners or pads on the sliding surface of the peripherals. These runners can be made of Teflon in order to lower the coefficient of friction between the peripheral and the support on which it rests.

However, the force necessary for moving the peripheral often remains very high, leading to fatigue in the user during prolonged use of the peripheral. Moreover, the movement of the pointer is often jerky, since the force needed to move the peripheral is often irregular. In particular, when the peripheral is immobile, a greater force is needed to start the peripheral moving. Thus, the user can experience difficulties in quickly moving the pointer toward a precise point of the screen. With progressive use of the peripheral, the pads can wear, leading to a further increase in the force needed to move the peripheral and/or making it irregular. In order to improve the use of these peripherals, users often resort to a specific mat, termed a mouse mat, further reducing the coefficient of friction with the sliding surface of the peripheral. However, these mats are bulky and present a limited surface on which the peripheral is to move. Alternatively, users can choose to use flat work areas comprising a very smooth surface, such as glass, for example. However, the use of very smooth surfaces is generally incompatible with the optical system that allows the translational movement of the peripheral to be detected.

The object of the invention is that of providing an equipment item for a computer peripheral and a method for mounting such an equipment item that overcome the disadvantages above and improve the computer peripherals known from the prior art.

More precisely, a first subject matter of the invention is an equipment item allowing an improvement in the sliding behavior of the peripherals so as to improve the use comfort and allow use on irregular surfaces.

A second subject matter of the invention is an equipment item compatible with a large majority of existing peripherals.

A third subject matter of the invention is an equipment item that is easy to manufacture and to install.

The invention relates to an equipment item for a computer peripheral, the equipment item comprising a set of at least four runners, the peripheral being intended to slide on a support, the base being intended to face the support, in particular the peripheral being a computer mouse, each runner of the equipment item comprising a first ceramic surface in the form of a portion of a sphere and a fastening means for fastening the runner below a base of a peripheral, each runner of the equipment item comprising a cylindrical portion, the cylindrical portion being intended to be fastened against a base of a peripheral.

Said portion of a sphere can have a radius of curvature of between 8 mm and 15 mm inclusive, in particular between 10 mm and 13 mm inclusive, or even between 11 mm and 12 mm inclusive.

Each runner of the equipment item can comprise a second surface of flat and circular shape, the fastening means being arranged on the second surface, the diameter of the second surface being between 20 mm and 30 mm inclusive, in particular between 25 mm and 28 mm inclusive, or even between 26 mm and 27 mm inclusive.

Each runner of the equipment item can comprise a thickness strictly less than 1.5 mm, in particular strictly less than 1.25 mm.

The thickness of the cylindrical portion of each runner can be between 0.4 mm and 0.8 mm inclusive, in particular between 0.5 mm and 0.7 mm inclusive.

The fastening means can be an adhesive surface, in particular the adhesive surface being protected by a protective film.

The invention also relates to a method for mounting an equipment item as defined above below a base of a peripheral, the method comprising:
a step of identifying a region of the base extending in one and the same plane, and then
a step of fastening a first runner to said region, in the vicinity of a first outer edge of said region, and then
a step of fastening a second runner to said region, in the vicinity of a second outer edge of said region, and then
a step of fastening a third runner to said region, in the vicinity of a third outer edge of said region, the third runner not being aligned in the axis defined by the first runner and the second runner, and then
a step of fastening a fourth runner to said region, in the vicinity of a fourth outer edge of said region, the fourth runner not being aligned in the axis defined by the first runner and the second runner, nor in the axis defined by the second runner and the third runner, nor in the axis defined by the first runner and the third runner,

the first runner, the second runner, the third runner and the fourth runner being arranged in such a way that the peripheral can rest in a stable manner on a flat support via the four runners.

The first outer edge, the second outer edge, the third outer edge and the fourth outer edge are chosen from among a front left edge, a front right edge, a rear left edge and a rear right edge of said region.

The identification step can comprise:
determining a first part of the base able to bear on a flat support,
determining a second part of the base set back with respect to the first part,

said region being chosen in the second part.

The equipment item can comprise a use notice to allow a user to implement the mounting method as defined above.

The invention also relates to a peripheral for a computer comprising:
a base intended to face a support;
at least four runners emanating from an equipment item as defined above, the four runners being fastened below the base, and
a sensor able to emit a signal dependent on a movement of the peripheral parallel to the support.

Finally, the invention also relates to a computer comprising a computing unit, a screen able to display a pointer, and a peripheral as defined above, the computing unit being able to convert said signal into a command for moving a pointer displayed on the screen.

These objects, features and advantages of the present invention will be explained in detail in the following description of one particular embodiment given in a nonlimiting manner with reference to the appended figures, in which:

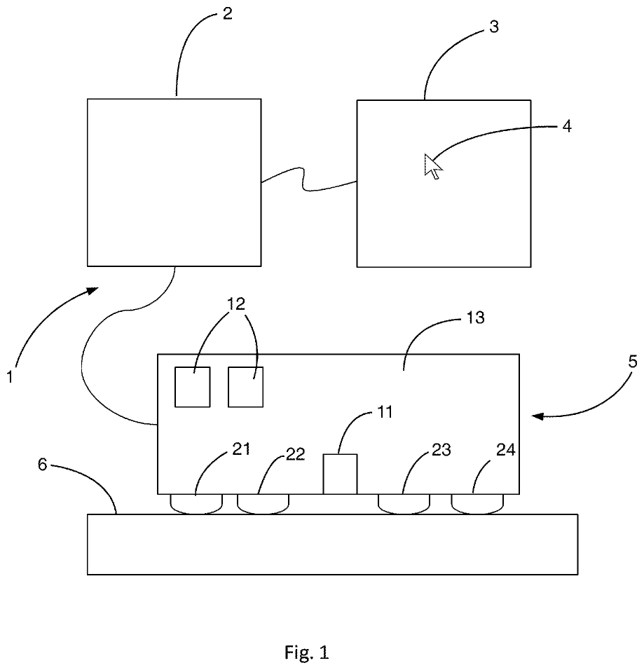

FIG. 1 is a schematic view of a computer according to one embodiment of the invention.

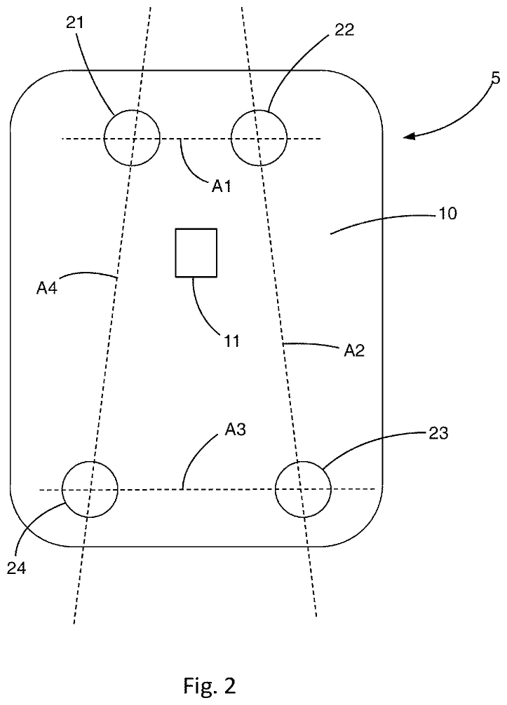

FIG. 2 is a schematic bottom view of a peripheral according to one embodiment of the invention.

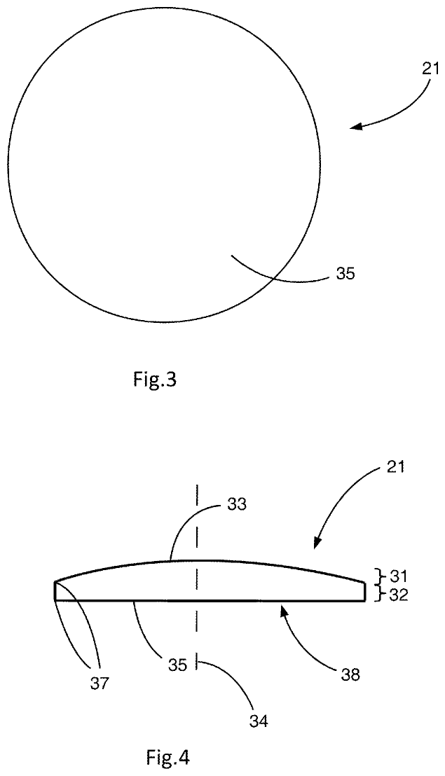

FIG. 3 is a front view of a runner according to one embodiment of the invention.

FIG. 4 is a profile view of the runner.

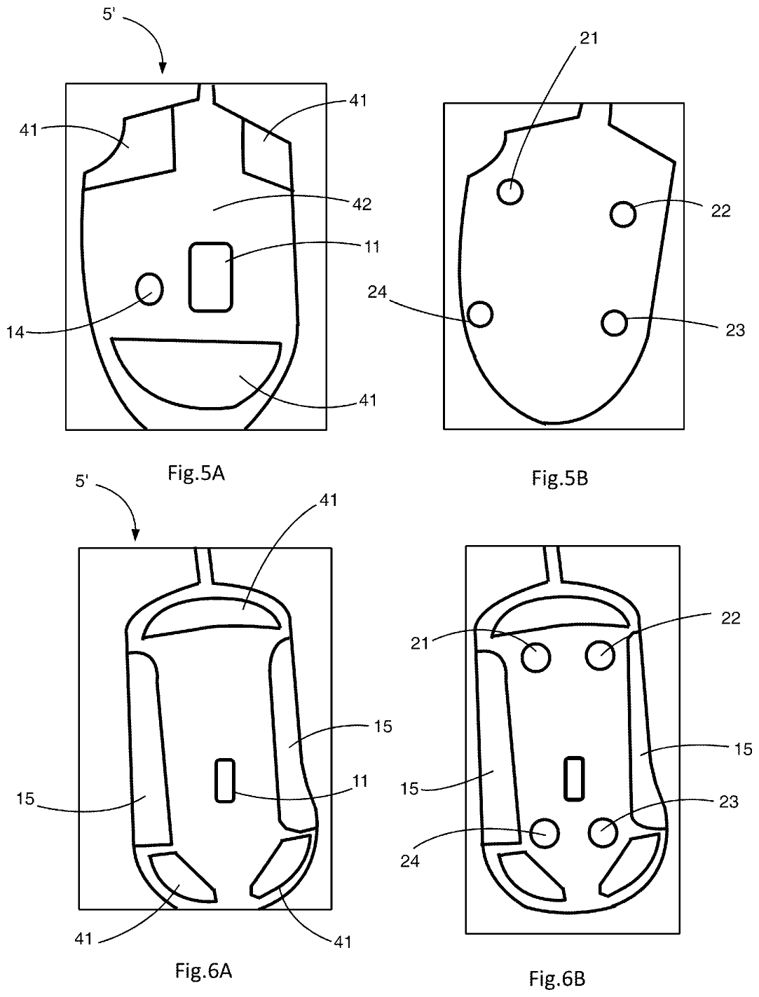

FIG. 5A is a photograph of the bottom of a first peripheral according to the prior art.

FIG. 5B is a photograph of the bottom of the first peripheral provided with an equipment item according to one embodiment of the invention.

FIG. 6A is a photograph of the bottom of a second peripheral according to the prior art.

FIG. 6B is a photograph of the bottom of the second peripheral provided with an equipment item according to one embodiment of the invention.

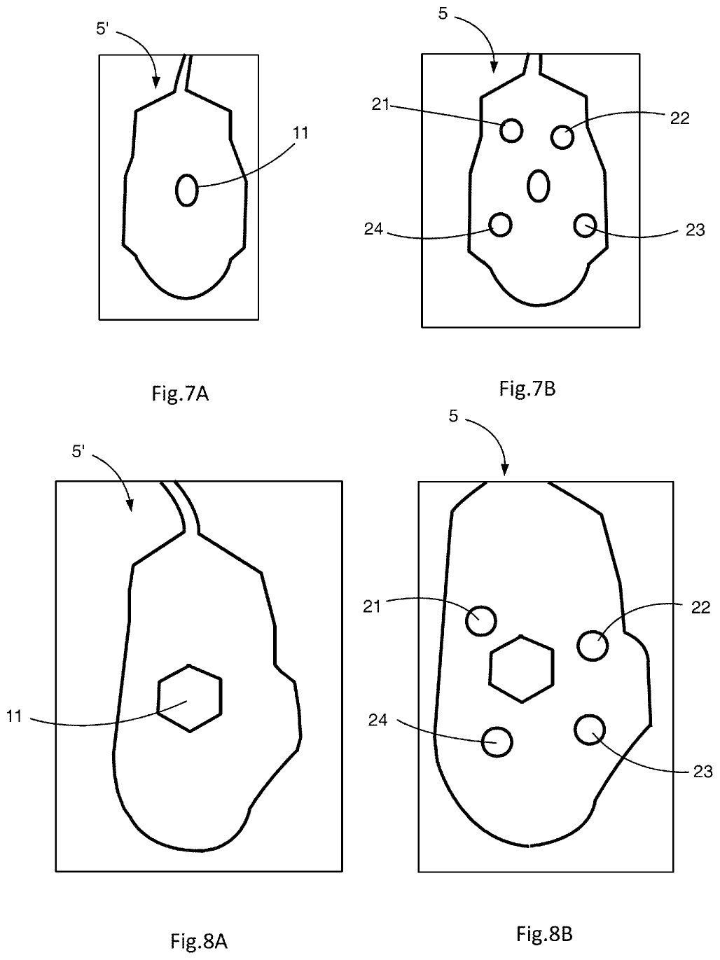

FIG. 7A is a photograph of the bottom of a third peripheral according to the prior art.

FIG. 7B is a photograph of the bottom of the third peripheral provided with an equipment item according to one embodiment of the invention.

FIG. 8A is a photograph of the bottom of a fourth peripheral according to the prior art.

FIG. 8B is a photograph of the bottom of the fourth peripheral provided with an equipment item according to one embodiment of the invention.

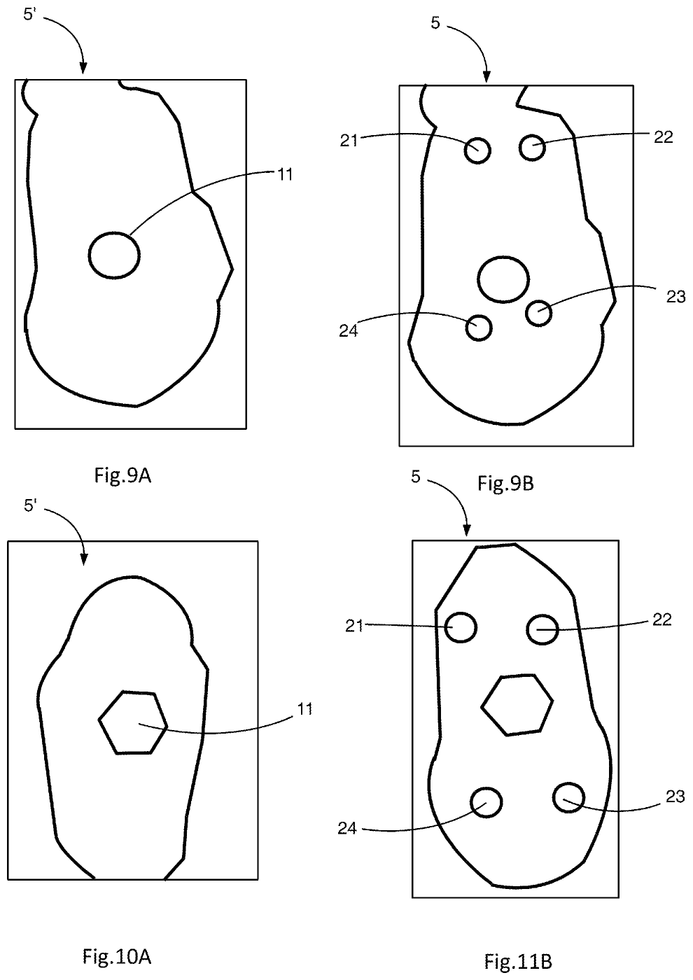

FIG. 9A is a photograph of the bottom of a fifth peripheral according to the prior art.

FIG. 9B is a photograph of the bottom of the fifth peripheral provided with an equipment item according to one embodiment of the invention.

FIG. 10A is a photograph of the bottom of a sixth peripheral according to the prior art.

FIG. 11B is a photograph of the bottom of a seventh peripheral provided with an equipment item according to one embodiment of the invention.

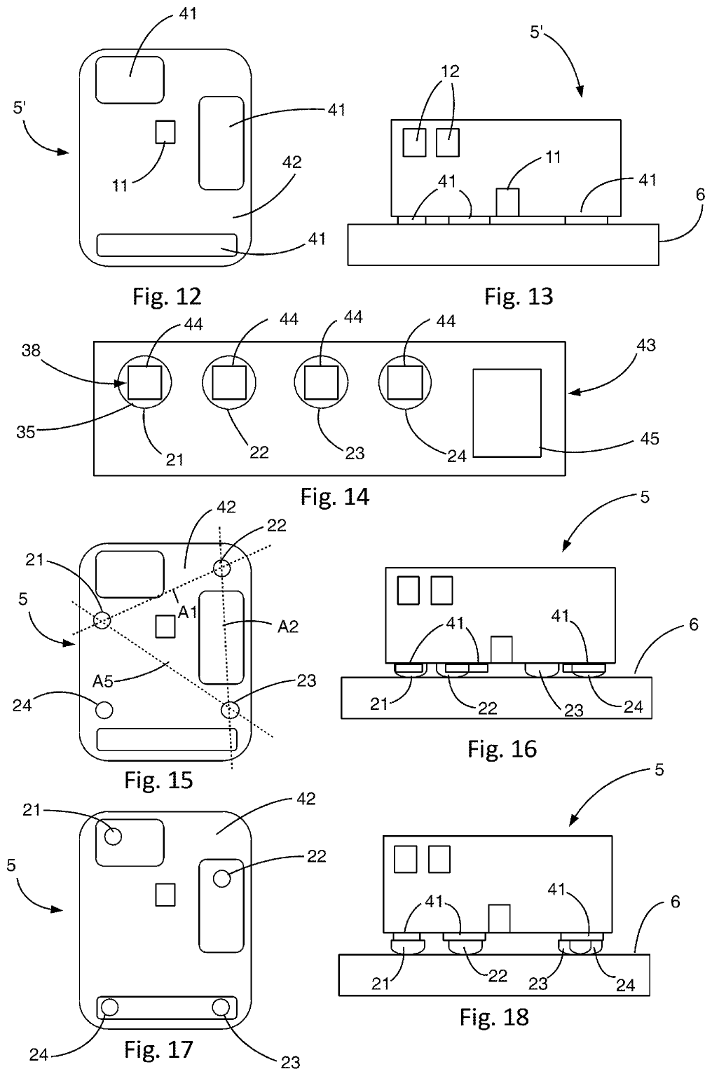

FIG. 12 is a schematic bottom view of a peripheral according to the prior art.

FIG. 13 is a schematic profile view of a peripheral according to the prior art.

FIG. 14 is a schematic view of an equipment item according to one embodiment of the invention.

FIG. 15 is a schematic bottom view of a peripheral according to one embodiment of the invention.

FIG. 16 is a schematic profile view of the peripheral according to one embodiment of the invention.

FIG. 17 is a schematic bottom view of a peripheral according to one alternative embodiment of the invention.

FIG. 18 is a schematic profile view of the peripheral according to one alternative embodiment of the invention.

FIG. 1 illustrates a computer 1 comprising a computing unit 2, a screen 3 able to display a pointer 4, and a peripheral 5 according to one embodiment of the invention. The computer 1 can be, for example, an office computer or a portable computer. The computing unit 2 can in particular comprise at least one microprocessor and at least one memory able to store code instructions. The screen 3 and the peripheral 5 are connected to the computing unit 2, for example by a wire link or even by a wireless link.

The peripheral 5 is a pointing device. It comprises a base 10. The base 10 is a face of the peripheral that is generally flat and faces a support 6 on which the peripheral 5 rests. The support is flat, that is to say that it generally extends in one plane. The support 6 can be in particular a flat work surface, a table or else a desk. Preferably, the support 6 is substantially horizontal but, as a variant, it could be inclined, such as, for example, a drawing table. The support 6 can be made of any material, such as, for example, wood, in particular raw wood, agglomerated wood such as plywood or else painted or varnished wood. The support 6 can also be made of plastic, of resin, of metal or else of glass. The surface state of the support 6 can be smooth or irregular, or even rough. It can comprise scratches, dirt or even holes. When the peripheral 5 rests on the support 6, the base 10 is substantially parallel to the support 6. According to one preferred embodiment of the invention, the peripheral 5 is a computer mouse but, as a variant, the invention can be used for any peripheral intended simultaneously to be connected to a computer and to be manipulated by sliding over a support.

The peripheral 5 further comprises a sensor 11 able to emit a signal destined for the computing unit 2. The signal depends on a movement of the peripheral in the plane defined by the support 6. The computing unit is able to convert the signal emitted by the peripheral into a command for moving the pointer 4 displayed on the screen 3. Thus, the user of the peripheral is able to interact with the computer 1. The sensor 11 can be in particular an optical sensor or a laser sensor. The sensor 11 is therefore a peripheral movement sensor. The sensor 11 is a contactless sensor, that is to say that it does not require contact between a member of the sensor and the support 6. It is arranged on the base 10 so as to cooperate with the support 6.

The peripheral 5 can further comprise any number of control means 12, such as buttons, a scroll wheel, or even a joystick. These control means 12 are arranged on a housing 13 surmounting the base 10. Advantageously, the peripheral 5 can be manipulated with the palm of one hand.

The peripheral 5 also comprises four runners 21, 22, 23, 24 according to one embodiment of the invention. As a variant, the peripheral could comprise five or even more runners. Preferably, the four runners 21, 22, 23, 24 are identical but, as a variant, they could have different shapes while having the same thickness. They are positioned such that the peripheral 5 rests on the support 6 only by way of the runners. All of the runners simultaneously touch the support 6. The peripheral 5 is therefore hyperstatically connected to the support 6.

As depicted in FIG. 2, the runners 21, 22, 23, 24 are fastened and distributed below the base 10 of the peripheral 5. There can be defined a first axis A1 passing through the center of the first runner 21 and through the center of the second runner 22. Likewise, there is defined a second axis A2 passing through the center of the second runner 22 and through the center of the third runner 23. Likewise, there is defined a third axis A3 passing through the center of the third runner 23 and through the center of the fourth runner 24. Likewise, there is defined a fourth axis A4 passing through the center of the fourth runner 24 and through the center of the first runner 21. None of the axes A1, A2, A3 and A4 are coincident. In particular, these four axes form a quadrilateral with a runner arranged at the four corners of the quadrilateral. In other words, there does not exist any subassembly of three runners aligned with one another. Advantageously, the runners are arranged in such a way that the peripheral can rest in a stable manner on the support 6 via the four runners. In particular, the runners do not touch one another. The projection of the center of gravity of the peripheral 5 on the base 10 is situated inside the quadrilateral formed by the four sides A1, A2, A3, A4. Thus, when a user manipulates the peripheral, the latter is not at risk of tilting or of overturning.

What will now be described is a first runner 21, considering the other three runners 22, 23, 24 to be identical. The runner 21 is depicted in FIGS. 3 and 4. The runner 21 can be broken down into a portion of a sphere 31 and a cylindrical portion 32. The portion of a sphere 31 comprises a first spherical surface 33. The cylindrical portion 32 comprises a base and a set of generatrices extending parallel to an axis of revolution 34 of the runner 21. The base has a circular shape and forms a second surface 35 of the runner 21. The set of generatrices forms a third surface 36 of the runner 21. Fillets 37 can be provided at the interface between the first surface 33 and the third surface 36, and also at the interface between the second surface 35 and the third surface 36. These fillets can have a radius substantially equal to 0.2 mm. The axis of revolution 34 is substantially perpendicular to the plane in which the base 10 extends.

Furthermore, the runner 21 comprises a fastening means 38, in particular an adhesive means, by which the runner is fastened below the base 10 of the peripheral. As a variant, the cylindrical portion 32 could be replaced by a portion of any shape, for example a portion of parallelepipedal shape.

The runner 21 can be in one piece and manufactured from ceramic. As a variant, only the first surface 33 could be of ceramic and the rest of the runner could be manufactured using a less precious material. For example, the runner could be manufactured from plastic and comprise a ceramic coating on the first surface. The ceramic material has a very high hardness. Thus, the contact surface of the runner against the support is very weak, thereby reducing the effects of friction of the runner against the support. Moreover, by virtue of its high degree of hardness, the runners cannot scratch during their use, thereby making it possible to maintain very good sliding of the peripheral throughout the length of its use.

Said portion of a sphere has a radius of curvature of between 8 mm and 15 mm inclusive, in particular between 10 mm and 13 mm inclusive, or even between 11 mm and 12 mm inclusive, or even substantially equal to 11.25 mm. With such a value of radius, the runner 21 can easily pass above any unevenness present on the surface of the support 6, or, in other words, closely follow the irregularities of the support. By contrast with the pads of the prior art, the shape in the portion of a sphere prevents any jamming or hooking of the runner against a relief of the support during the movement of the peripheral. By virtue of its shape as a portion of a sphere, the contact between a runner and the support is a point contact or virtual point contact, thereby making it possible to reduce friction. The shape of the runners therefore runs against the commonly accepted idea of the manufacturers of peripherals whereby the pads forming the sliding surface of the mice have to be wide in order to make the sliding effect homogeneous or regular.

The diameter of the second surface is between 20 mm and 30 mm inclusive, in particular between 25 mm and 28 mm inclusive, or even between 26 mm and 27 mm inclusive, or even substantially equal to 26.67 mm. This diameter is an ideal compromise between, on the one hand, a small space requirement allowing the runner to be fastened to a small-sized surface of the base, and, on the other hand, an adhesive surface between the runner and the base that is sufficiently large to ensure sufficient strength of the runners. This surface is also sufficiently large to produce a significant portion of a sphere and thus to allow the runner to pass above the unevenness of the support. Thus, the thickness of the portion of a sphere (in other words its height along the axis perpendicular to the plane of the base) can be between 0.4 mm and 0.8 mm, in particular between 0.5 mm and 0.7 mm, or even substantially equal to 0.6 mm.

The runner 21 comprises a total thickness, in other words a total height, strictly less than 1.5 mm, in particular strictly less than 1.25 mm, and in particular approximately equal to 1.2 mm according to the embodiment illustrated in FIG. 4. This height is particularly low and makes it possible to obtain a minimum superelevation of the peripheral 5 after fastening of the runners 5. The superelevation of the peripheral 5 is, however, sufficient to allow it not to butt against unevenness of the support 6. Thus, the operation of the sensor 11 is not disturbed, and the position of the pointer 4 displayed on the screen can be controlled with precision. Likewise, taking hold of the peripheral is unappreciably modified. The thickness, in other words the height, of the cylindrical portion can be between 0.4 mm and 0.8 mm inclusive, in particular between 0.5 mm and 0.7 mm inclusive, in particular be equal to approximately 0.6 mm. As a variant, the thickness of the cylindrical portion could be even smaller. The presence of a cylindrical portion in the runner 21 makes it possible to simplify its manufacture. Specifically, the presence of the cylindrical portion makes it possible to avoid having a runner with a sharp edge. Such a sharp edge would be particularly brittle. The breakage of the edge of the runner could reduce the area of contact between the runner and the base and make it less adherent. Moreover, such a breakage could be nonesthetic and/or give a quality impression perceived to be degraded. Moreover, the cylindrical portion makes it possible to raise the base 10 with respect to the support, thereby improving the capacity of the mouse to slide over uneven surfaces or surfaces having particles that could otherwise jam between the support 6 and the base 10. The presence of a cylindrical portion makes it possible to freely choose the radius of the spherical surface without having to modify the superelevation of the base of the peripheral with respect to the surface on which the peripheral rests and/or without having to modify the area of contact between the runner and the base.

What will now be described is the method for manufacturing the peripheral 5.

In a first step, there is provided any peripheral 5′ devoid of the runners 21, 22, 23, 24. The peripheral 5′ can be a new peripheral or a peripheral which has already been used. The peripheral 5′ can in particular be a computer mouse of the prior art. In the case that the peripheral 5′ has already been used, its base may have been cleaned beforehand. Such a peripheral 5′ is in particular illustrated in FIGS. 12 and 13. The base comprises a sliding surface, that is to say a part of the base by which the peripheral 5′ had until then been in contact with a support. The sliding surface forms a first part 41 of the base. This sliding surface can be, for example, produced with Teflon pads which are types of runner whose surface is flat. The sliding surface can be constituted by a plurality of separate regions (that is to say noncontiguous regions) distributed over the base. Outside of the sliding surface, the base comprises a region set back with respect to the sliding surface. This region is therefore not in contact with the support 6 and forms a second part 42 of the base that is complementary with the first part 41. This second part can comprise a flat region substantially parallel to the sliding surface and set back with respect to the sliding surface. The base can further comprise reliefs or markings or else the sensor 11. These elements can form irregularities at the surface of the base but which nevertheless remain set back with respect to the sliding surface.

In a second step, there is provided an equipment item 43 comprising the four runners 21, 22, 23, 24. Such an equipment item is in particular illustrated in FIG. 14 and can be found in the form of a box, or of a kit comprising the runners 21, 22, 23, 24. The box can comprise a larger number of runners intended to be fastened below the base of one and the same peripheral. The number of runners can even be sufficient to equip a plurality of peripherals in the knowledge that at least four runners are required to equip a peripheral. Each runner comprises, on its second face, a fastening means 38, in this instance an adhesive means, making it possible to fasten each runner below the base of the peripheral. Advantageously, the adhesive means can be covered by a protective film 44 standing by to be used. The adhesive means can cover the whole of the second surface 35 or, as a variant, only part of the second surface. As a variant, the adhesive means could take the form of a double-sided adhesive tape and the user would then be tasked with himself sticking a first side of the adhesive tape to the second surface. According to another variant, the adhesive means could be replaced by a reserve of glue that the user would be tasked with applying to the second surface.

In a third step, there is identified on the base of the peripheral a region extending in one and the same plane and to which the four runners will be able to be fastened. This region can be the first part 41 or the second part 42 of the base. This region does not comprise the sensor 11 in order not to mask it with a runner. When the runners are fastened in the second part of the base, that is to say a part of the base that does not form the sliding surface and that is therefore set back with respect to the sliding surface, the superelevation of the peripheral obtained is thus advantageously less than the thickness of the runners 21, 22, 23, 24. The proper functioning of the sensor 11 and/or the taking hold of the peripheral is all the less adversely affected as a result.

In a fourth step, the four runners are successively fastened to the previously identified region. FIGS. 15 and 16 illustrate the peripheral 5 to which the runners are fastened in the second region 42.

FIGS. 17 and 18 illustrate the peripheral 5 to which the runners are fastened in the first region 41. Each runner is fastened in the vicinity of an outer edge of the region in question. In particular, the first runner 21 is fastened in the vicinity of a left front edge of the region in question. The second runner 22 is fastened in the vicinity of a right front edge of the region in question. The third runner 23 is fastened in the vicinity of a right rear edge of the region in question. The fourth runner 24 is fastened in the vicinity of a left rear edge of the region in question. Thus, the quadrilateral formed by the four runners has a large surface as compared with the surface of the base 10, and the peripheral remains stable.

The third runner 23 is not aligned in the axis defined by the first runner and the second runner. The fourth runner is not aligned in the axis A1 defined by the first runner and the second runner, nor in the axis A2 defined by the second runner and the third runner, nor in the axis A5 defined by the first runner and the third runner. Thus, the four runners are positioned at the four corners of a quadrilateral defined by the axes A1, A2, A3 and A4, and the peripheral can rest in a stable manner on a flat support via the four runners.

A use notice 45 or a manual detailing the operating mode to be followed for fastening the runners 21, 22, 23, 24 can be affixed to the equipment item 43 in such a way as to allow the user to himself proceed with mounting the runners.

Incidentally, the presence of at least four runners on the base defines a hyperstatic position of the peripheral. However, since the runners are fastened to one and the same plane of the base and comprise one and the same height, they simultaneously bear on the support and the peripheral is not wobbly. Assuming slight variations in height between the runners occurring (for example on account of a lack of planarity of the surface to which the runners are fastened or on account of the manufacturing tolerances of the runners), the simultaneous bearing contact of the four runners could nevertheless be obtained by virtue of a deformation of the base of the peripheral under its own weight and under the weight of the user's hand.

FIGS. 5A, 6A, 7A, 8A, 9A and 10A are photographs of peripherals 5′ before mounting the runners 21, 22, 23, 24. FIGS. 5B, 6B, 7B, 8B, 9B and 11B are photographs of these same peripherals after the runners have been mounted.

As can be observed in FIG. 5A, the base comprises three pads defining a sliding surface and forming the first part 41 of the base. The base also comprises a sensor 11 and various accessories in relief, such as, for example, a switch 14 for turning the mouse on/off. Outside of the first part 41 and of the sensor 11 and of the accessories in relief, the base extends along a plane on which there appear inscriptions. This plane forms the second part of the base to which there are fastened the four runners 21, 22, 23, 24 according to FIG. 5B.

In FIG. 6A, it is observed that the base comprises, apart from the three pads, two lateral cutouts 15. As illustrated in FIG. 6B, care is taken not to fasten the runners in these cutouts to ensure that the mouse bears stably on the support.

In FIG. 8A, it is observed that the base comprises a complex shape with numerous reliefs. By virtue of the relatively restricted dimensions of the runners, and in particular of the second surface of the runners, there is nevertheless managed to be found a region of the base on which to fasten the runners. Incidentally, the whole of the second surface does not necessarily have to be glued to the base: a part of the second surface of each runner can be found opposite a set-back region of the base and therefore not participate in the adherence of the runner to the base. Advantageously, the adhesive means is chosen so as to produce sufficient strength of the runner even if only one part of the adhesive means is in contact with the base.

Finally, whatever the peripheral in question, there is managed to be identified a region of the base extending along one and the same plane and to which there can be fastened the four runners while maintaining good stability of the peripheral.

According to another arrangement variant, it is possible to fasten two runners to a first plane of the base, for example the runners 21 and 22, and to fasten the other two runners 23, 24 to a second plane of the base set back with respect to the first plane. In this case, the user will take care to ensure that the axis A1 defined between the first runner 21 and the second runner 22 is duly parallel to the axis A3 defined between the third runner and the fourth runner. It will thus be possible to maintain bearing of the peripheral simultaneously with the four runners. The base of the peripheral may thus be located very slightly inclined with respect to the support, which will not interfere with its use.

According to another aspect of the invention, a database comprising a list of peripherals available on the market may be made available to the user. For each peripheral, the database could confirm the possibility of fastening the runners to a region of the base and specify the locations where these runners are to be arranged. This database could, for example, be accessible from the Internet.

By virtue of the invention, there is made available an equipment item which is compatible with a large majority of existing peripherals and easy to install by oneself. The equipment item makes it possible to improve the sliding behavior of the peripherals without requiring the complete replacement of the peripheral. It makes it possible to use the peripheral on irregular surfaces which, with pads according to the prior art, would produce use discomfort.

1. An equipment item for a computer peripheral, comprising:
a set of at least four runners,
the peripheral being intended to slide on a support, the base being intended to face the support,
each runner of the equipment item comprising a first ceramic surface in the form of a portion of a sphere, and a fastening means for fastening the runner below a base of a peripheral, and
each runner of the equipment item comprising a cylindrical portion, the cylindrical portion being intended to be fastened against a base of a peripheral.

2. The equipment item as claimed in the preceding claim, further including that said portion of a sphere has a radius of curvature of between 8 mm and 15 mm inclusive, in particular between 10 mm and 13 mm inclusive, or even between 11 mm and 12 mm inclusive.

3. The equipment item (43) as claimed in claim 1, further including that each runner of the equipment item comprises a second surface of flat and circular shape, the fastening means being arranged on the second surface, the diameter of the second surface being between 20 mm and 30 mm inclusive.

4. The equipment item as claimed in claim 1, further including that each runner of the equipment item comprises a thickness strictly less than 1.5 mm.

5. The equipment item as claimed in claim 1, further including that the thickness of the cylindrical portion of each runner is between 0.4 mm and 0.8 mm inclusive.

6. The equipment item as claimed in claim 1, further including that the fastening means is an adhesive surface, in particular the adhesive surface being protected by a protective film.

7. A method for mounting an equipment item as claimed in claim 1 below a base of a peripheral, comprising:
a step of identifying a region of the base extending in one and the same plane, and then
a step of fastening a first runner to said region, in the vicinity of a first outer edge of said region, and then
a step of fastening a second runner to said region, in the vicinity of a second outer edge of said region, and then
a step of fastening a third runner to said region, in the vicinity of a third outer edge of said region, the third runner not being aligned in the axis defined by the first runner and the second runner, and then
a step of fastening a fourth runner to said region, in the vicinity of a fourth outer edge of said region, the fourth runner not being aligned in the axis defined by the first runner and the second runner, nor in the axis defined by the second runner and the third runner, nor in the axis defined by the first runner and the third runner,
the first runner, the second runner, the third runner and the fourth runner being arranged in such a way that the peripheral can rest in a stable manner on a flat support via the four runners.

8. The mounting method as claimed in the preceding claim, characterized in that the first outer edge, the second outer edge, the third outer edge and the fourth outer edge are chosen from among a left front edge, a right front edge, a left rear edge and a right rear edge of said region.

9. The mounting method as claimed in claim 7, further including that the identification step comprises:
determining a first part of the base able to bear on a flat support,
determining a second part of the base set back with respect to the first part, said region being chosen in the second part.

10. The equipment item as claimed in claim 1, further including that it comprises a use notice to allow a user to implement the mounting method.

11. A peripheral for a computer, comprising:
a base intended to face a support;
at least four runners emanating from an equipment item as claim 1, the four runners being fastened below the base, and
a sensor able to emit a signal dependent on a movement of the peripheral parallel to the support.

12. A computer, comprising:
a computing unit,
a screen able to display a pointer, and
a peripheral as claimed in claim 11,
the computing unit being able to convert said signal into a command for moving a pointer displayed on the screen.

13. The equipment item as claimed in claim 1, wherein the peripheral is a computer mouse.

14. The equipment item as claimed in claim 3, wherein the diameter of the second surface is between 25 mm and 28 mm inclusive.

15. The equipment item as claimed in claim 14, wherein the diameter of the second surface is between 26 mm and 27 mm inclusive.

16. The equipment item as claimed in claim 4, wherein said thickness of the equipment item is strictly less than 1.25 mm.

17. The equipment item as claimed in claim 5, wherein said thickness of the cylindrical portion of each runner is between 0.5 mm and 0.7 mm inclusive.
